(19) United States
(12) Patent Application Publication
(10) Pub. No.: US 2022/0391230 A1
(43) Pub. Date: Dec. 8, 2022

(54) NOTIFICATION ABOUT SCREEN SHARING WHEN SWITCHING BETWEEN APPLICATIONS

(71) Applicant: Avaya Management L.P., Durham, NC (US)

(72) Inventors: Tanvi Sharma, Pune (IN); Pragati Kailash Dhumal, Pune (IN); Navanath Dattatray Navaskar, Pune (IN)

(21) Appl. No.: 17/337,511

(22) Filed: Jun. 3, 2021

(51) Int. Cl. G06F 9/451; G06F 9/54; G06F 9/48; G06F 3/0484

(52) U.S. Cl. CPC G06F 9/452; G06F 9/542; G06F 9/48; G06F 3/04842

(57) ABSTRACT

The technology disclosed herein enables notifications to a user about screen sharing being active when switching between applications. In a particular embodiment, a method includes capturing a view displayed by a first user system to a user, where the view includes a first window of a first application, and sharing the view with a second user system. The second user system displays the view. The method further includes receiving user input directing the first user system to display, in the view, a second window of a second application. Before including the second window in the view, the method includes notifying the user that the view is being shared.

### TECHNICAL BACKGROUND

A screen sharing client executing on a user system captures views displayed by the user system (e.g., entire desktops, particular application windows, etc.) and sends the views to one or more other systems for display thereat. Users at the other systems are then able see what the user system is displaying without having to be located at the user system. Many screen sharing clients are incorporated into telecommunication clients (e.g., a videoconferencing client), which provides screen sharing features to participants on telecommunication sessions. For example, a user may want to show a document to other users on a telecommunication session and initiates a screen sharing session to share their desktop view, which includes a window showing the document, accordingly. If the user chooses to switch to a different application from the application showing the document, the other users will also see that different application over the screen sharing session. Preferably, the user is cognizant of their screen being shared when switching to the different application. However, if the user has forgotten about their screen being shared, then the user may inadvertently share displayed information (e.g., an application window for the different application) that they do not actually want the other users to see.

### SUMMARY

The technology disclosed herein enables notifications to a user about screen sharing being active when switching between applications. In a particular embodiment, a method includes capturing a view displayed by a first user system to a user, where the view includes a first window of a first application, and sharing the view with a second user system. The second user system displays the view. The method further includes receiving user input directing the first user system to display, in the view, a second window of a second application. Before including the second window in the view, the method includes notifying the user that the view is being shared.

In some embodiments, after notifying the user, the method includes receiving confirmation from the user that the second window should be included in the view and, in response to receiving the confirmation, including the second window in the view. In those embodiments, before receiving the confirmation, the method may include an obscured version of the second window in the view.

In some embodiments, after notifying the user, the method includes receiving an instruction from the user to cancel the user input.

In some embodiments, before receiving the user input, the method includes receiving a selection of one or more applications for which the user should be notified. The selection includes the second application.

In some embodiments, the method includes receiving second user input from the user identifying one or more applications that trigger notification to the user when directed to be included in the view. The one or more applications include the second application. In those embodiments, the method may include requesting the second user input in response to initializing the sharing of the view. Also, in those embodiments, the method may include receiving third user input directing the first user system to display, in the view, a third window of a third application and, in response to determining that the third application is not included in the one or more applications, including the third window in the view.

In some embodiments, the user input comprises user input directing the first user system to share the view, or the user input initiates execution of the second application.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to capture a view displayed by a first user system to a user, where the view includes a first window of a first application, and share the view with a second user system, wherein the second user system displays the view. The program instructions further direct the processing system to receive user input directing the first user system to display, in the view, a second window of a second application. Before including the second window in the view, the program instructions direct the processing system to notify the user that the view is being shared.

### BRIEF DESCRIPTION OF THE DRAWINGS

FIG. 1 illustrates an implementation for notifying a user about screen sharing when switching between applications.

FIG. 2 illustrates an operational scenario to notify a user about screen sharing when switching between applications.

FIG. 3 illustrates a desktop for notifying a user about screen sharing when switching between applications.

FIG. 4 illustrates a desktop for notifying a user about screen sharing when switching between applications.

FIG. 5 illustrates a desktop for notifying a user about screen sharing when switching between applications.

FIG. 6 illustrates a desktop for notifying a user about screen sharing when switching between applications.

FIG. 7 illustrates a desktop for notifying a user about screen sharing when switching between applications.

FIG. 8 illustrates an operational scenario to notify a user about screen sharing when switching between applications.

FIG. 9 illustrates a computing architecture for notifying a user about screen sharing when switching between applications.

### DETAILED DESCRIPTION

The view-sharing client described herein notifies a user when the user attempts to view an application that was not previously displayed while currently sharing the view presented by the user's system (e.g., the entire screen/desktop display or particular application windows thereon). Notifying the user may provide the user with an opportunity to stop the user system from switching to the application, to stop (or temporarily pause) the view sharing, to continue with the application switch, or perform some other relevant action. Even if the user has forgotten that their view is being shared, the view-sharing client will remind the user of the view sharing being enabled before the user potentially shares information over the view-sharing session that they do not want others to see. For example, the user may be sharing a document on their screen and decide to read their email. The view-sharing client notifies the user that their view is being shared when the user attempts to switch to an email application. If the user does not want other to see their emails, then the user may decide to not open the email application or end the view-sharing session.

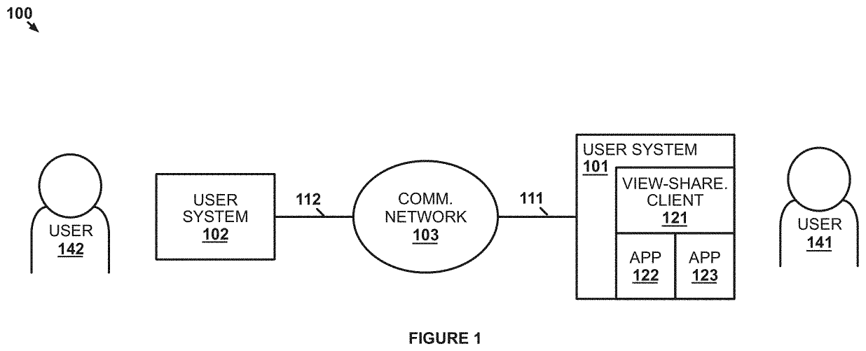

FIG. 1 illustrates implementation 100 for notifying a user about screen sharing when switching between applications. Implementation 100 includes user system 101, user system 102, and communication network 103. User system 101 and communication network 103 communication over communication link 111. User system 102 and communication network 103 communication over communication link 112. Communication links 111-112 may be wired and/or wireless. Communication links 111-112 are shown as direct links but may include intervening systems, networks, and/or devices. User systems 101-102 may each be a telephone, laptop, personal computer, tablet computer, or some other type of user operable computing system. Communication network 103 includes one or more networks, such as a circuit switched telephone network, local area packet network, wide area network (e.g., the Internet), or some other type of network over which telecommunications may be carried including combinations thereof.

In operation, view-sharing client 121 is an application executing on user system 101 to share the view presented on a display of user system 101 to user 141, who is operating user system 101. User system 101 also includes application 122 and application 123, which may present graphical user interface (GUI) elements (e.g., application windows) to user 141. The GUI elements, and/or other visuals, displayed by application 122 and application 123 may be captured by view-sharing client 121 and shared to other users systems when view sharing is enabled in view-sharing client 121.

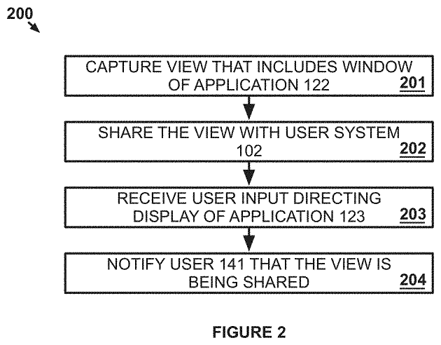

FIG. 2 illustrates operational scenario 200 to notify a user about screen sharing when switching between applications. In operational scenario 200, view-sharing client 121 captures a view displayed by user system 101 to user 141 (201). In this example, the view includes a window of application 122. Application 122 may be an application that includes view-sharing client 121, such as a telecommunications application or a dedicated screen sharing application, or may be a separate application, such as a document editing application, web-browsing application, media playback application, or any other type of application capable of executing on user system 101. The view may include only the window of application 122 (e.g., the window is full screen or user 141 has directed view-sharing client 121 to only capture the application window that currently has focus, which is the window of application 122 in this case) or may include other visuals being displayed by user system 101, such as a desktop (or other elements) displayed by an operating system executing on user system 101, one or more other application windows that are also being displayed by user system 101, or some other type of visual capable of being displayed by a user system.

View-sharing client 121 shares the view with user system 102 and user system 102 displays the view to user 142, who is operating user system 102 (202). In this example, the view is transmitted to user system 102 over communication network 103, although, the view may be transmitted to additional user systems in other examples. Though not shown, user system 102 may also execute a view-sharing client (e.g., another instance of view-sharing client 121 or a different client) to receive the view from user system 101 and present the view to user 142. In those examples, view-sharing client 121 may use proprietary protocols and view formats to exchange the view with user system 102. In some examples, the view may be transmitted in manners that do not require user system 102 to execute a complementary view-sharing client. For example, view-sharing client 121 may format the view as a video stream using a standardized video codec and any application capable of receiving/presenting that video stream (e.g., a web-browser) may be used. Regardless of how view-sharing client 121 provides the view to user system 102, the view continues to be captured by view-sharing client 121 and transmitted to user system 102 so that user system 102 can display the up-to-date view to user 142.

While the view is being shared, user system 101 receives user input directing user system 101 to display, in the view, a window of application 123 (203). The user input may be entered via a keyboard, mouse, touchscreen, microphone (e.g., voice command), video camera (e.g., physical gesture), or through some other type of user input interface. Application 123 may already be open (i.e., executing) on user system 101 prior to the user input or the user input may direct user system 101 to open application 123, which triggers application 123 to display a window. If application 123 is already executing, the window for application 123 may already exist while not being shown in the view (e.g., may be minimized, may be hidden, or mostly hidden, behind another window, may be hidden by the OS, or may not be included in the view for some other reason). In other cases, application 123 may already be executing without any windows open and the user input may direct application 123 to display a new window. The user input may likewise direct application 123 to display a new window in addition to any other windows that may already be open for the application. View-sharing client 121 may monitor a component of the OS of user system 101 to determine that the user input is directing user system 101 to display the window of application 123. For example, the OS may include a window manager that handles the display of application windows by user system 101. View-sharing client 121 may have access to the window manager such that view-sharing client 121 is notified by the window manager, or otherwise recognizes, that the window manager is about to bring a window of application 123 into the view. In another example, view-sharing client 121 may monitor a process manager of the OS to determine that application 123 is being opened or view-sharing client 121 may monitor a user input handler of the OS to identify the receipt of the user input.

Regardless of how the user input directs the window for application 123 to be displayed in the view, in response to the user input, view-sharing client 121 notifies the user that the view is being shared (204). The notification may include a visual alert (e.g., popup window notification), audible alert (e.g., tone(s) or voice playback), tactile alert (e.g., vibration), or some other manner in which user 141 would recognize that they are being notified that the view is being shared—including combinations thereof. In some cases, the window of application 123 may still be displayed, and included in the shared view, without interruption. In other cases, view-sharing client 121 may delay the display of the window of application 123 entirely or may otherwise prevent the window from being included in the shared view. The amount of time may be a predetermined amount of time that is preferably long enough in duration for user 141 to decide whether they want to manually prevent the window of application 123 from being included in the shared view (e.g., user 141 may manually instruct application 123 or the OS of user system 101 to not display the window or user 141 may pause/stop the sharing of the view). The amount of time may also be indefinite while view-sharing client 121 queries user 141 about whether they want to proceed with the window of application 123 being included in the shared view. The alert used by view-sharing client 121 to notify user 141 about the view sharing being active may also query user 141 about whether they want to proceed with including the window of application 123 in the view and may provide user 141 with the ability to answer that query (e.g., confirm that they want the inclusion to proceed or request that the inclusion be stopped).

View-sharing client 121 may prevent the window of application 123 from being included in the view for the amount of time by directing a window manager of the OS to not display the window of application 123, by directing the OS to not execute application 123, by obscuring the window (e.g., blurring the window, force minimizing the window, displaying the alert over the window, displaying a another window over the window, etc.) such that information displayed in the window cannot be viewed, by pausing or stopping the sharing of the view with user system 102, or by preventing the window of application 123 from being shared in the view to user system 102 in some other manner. View-sharing client 121 may prevent the window of application 123 from being included in the view by effecting the view before or after capture. For example, if the window of application 123 is blurred in the view, the blurred window may be displayed to user 141 by user system 101 and also captured by view-sharing client 121. Alternatively, view-sharing client 121 may capture the view with the window of application 123 being displayed and then blur the window prior to sharing the view with user system 102. In both of the above examples, user 142 is presented with a view having the window of application 123 blurred.

Advantageously, even if user 141 forgot that they were sharing their view with user 142, view-sharing client 121 reminds user 141 of the fact prior to user 141 allowing user 142 to see window content that user 141 potentially does not want them to see.

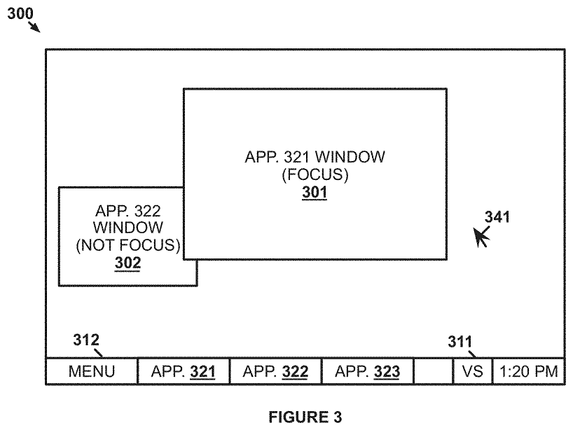

FIG. 3 illustrates desktop 300 for notifying a user about screen sharing when switching between applications. Desktop 300 is an example GUI of an operating system executing on user system 101 and is displayed by a display of user system 101. In this example, user system 101 is executing application 321, application 322, and application 323. Desktop 300 includes application window 301 of application 321 and window 302 of application 322. Window 301 is currently the focus window (e.g., the window that is at the forefront on desktop 300) while window 302 is not the focus and can, therefore, be behind window 301, as shown. Desktop 300 includes menu bar 312 at the bottom of the GUI, although, an OS in another example may position menu bar 312 elsewhere or not include menu bar 312 at all in favor of a different type of GUI. Menu bar 312 shows that application 321, application 322, and application 323 are currently open on user system 101. The right side of menu bar 312 includes tray 311, which shows that view-sharing client 121 (i.e., “VS”) is executing. In other examples, view-sharing client 121 may be included with applications 321-323 on menu bar 312 outside of the tray 311. In some examples, view-sharing client 121 may display a window on desktop 300 like window 301 and window 302. Cursor 341 is controlled by user 141 using a mouse to interact with elements displayed in desktop 300 (e.g., select icons, select windows, move windows, interact with windows, etc.). Other examples may use different user input devices to enable user 141 to move cursor 341 or may eschew cursor 341 altogether for interacting with desktop 300 (e.g., a touchscreen without a displayed cursor).

For the purposes of this example, the view captured by view-sharing client 121 and shared with user system 102 includes the entirety of desktop 300. Thus, everything shown on desktop 300 is captured, sent to user system 102, and displayed to user 142 (e.g., within a view sharing window or full screen). In other examples, view-sharing client 121 may capture less than all of desktop 300 for sharing. For instance, view-sharing client 121 may only capture and share window 301.

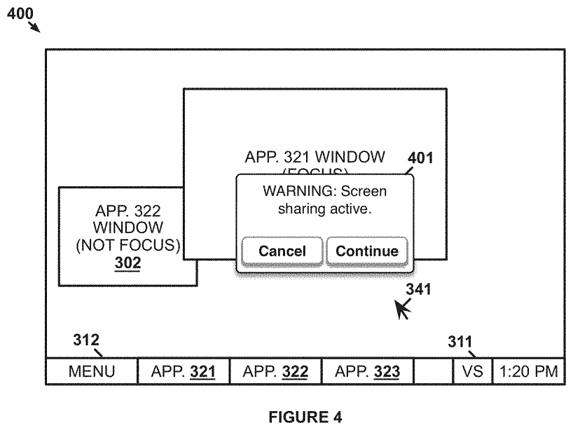

FIG. 4 illustrates desktop 400 for notifying a user about screen sharing when switching between applications. Desktop 400 is an example of desktop 300 after user 141 used cursor 341 to select application 323 from menu bar 312. A window for application 323 may already exist but is minimized into menu bar 312 (or is otherwise hidden) and the user selection of application 323 may then direct the OS to un-hide that window. Alternatively, application 323 may generate a new window upon being selected from menu bar 312 by user 141. Regardless, before the window of application 323 is displayed in desktop 400, view-sharing client 121 generates popup alert 401 to notify user 141 that the view of desktop 400 is currently being shared. Since popup alert 401 is on desktop 400, which is the view being captured in this example, popup alert 401 may be included in the view shared by view-sharing client 121 with user system 102. In other examples, view-sharing client 121 may not include popup alert 401 in the view (e.g., may pause sharing or may otherwise prevent user system 102 from presenting popup alert 401 at user system 102). Popup alert 401 provides user 141 with the option to continue with displaying the window of application 323 or to cancel the displaying of the window.

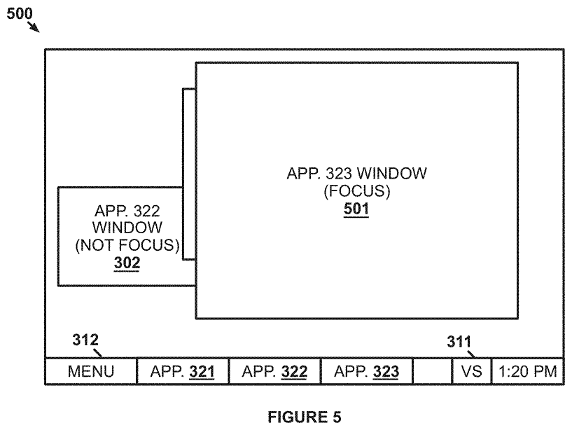

FIG. 5 illustrates desktop 500 for notifying a user about screen sharing when switching between applications. Desktop 500 is an example of desktop 400 after user 141 uses cursor 341 to select “Continue” from popup alert 401, which directs view-sharing client 121 to allow application 323 to display window 501. As such, window 501 is displayed on desktop 500 just as it would have been had view-sharing client 121 not first displayed popup alert 401. Had user 141 selected “Cancel” from popup alert 401, then view-sharing client 121 would have prevented window 501 from being included in the view. In those examples, view-sharing client 121 may instruct a window manager of the OS to close window 501 before window 501 can be displayed, which would result in a view of a desktop similar to desktop 300, view-sharing client 121 may obscure window 501 in the view until user 141 can take action to close window 501, view-sharing client 121 may pause the sharing of the view until user 141 can close window 501 (e.g., may restart the sharing after determining that window 501 is closed), or view-sharing client 121 may take some other action to prevent the contents of window 501 from being included in the view shared with user system 102.

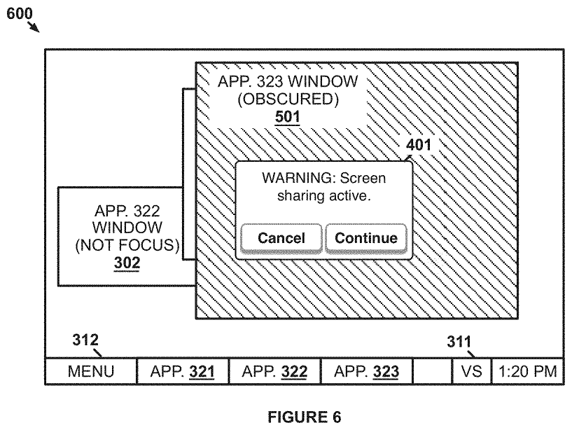

FIG. 6 illustrates desktop 600 for notifying a user about screen sharing when switching between applications. Desktop 600 is a different example from desktop 400 after user 141 used cursor 341 to select application 323 from menu bar 312. Rather than preventing window 501 from being displayed at all until receiving confirmation from user 141 that they wish to continue with the display, as was the case with desktop 400, desktop 600 displays window 501 and view-sharing client 121 obscures window 501 so that the contents of window 501 cannot be seen in the view. In this example, window 501 is obscured using a lined pattern to cover the contents of window 501, although, other manners of obscuring the contents (e.g., blurring) may be used in other examples. Thus, when desktop 600 is presented at user system 102 to user 142, user 142 is only able to see that window 501 exists but not the contents thereof. Should user 141 opt to continue with the display of window 501, view-sharing client 121 will stop obscuring window 501, which will result in a desktop similar to desktop 500. Should user 141 opt to cancel the display of window 501, then view-sharing client 121 may continue to obscure window 501 until user 141 instructs the OS to close window 501 or view-sharing client 121 may automatically close view-sharing client 121 itself, which reverts the view back to a desktop similar to desktop 300 with no window 501 displayed.

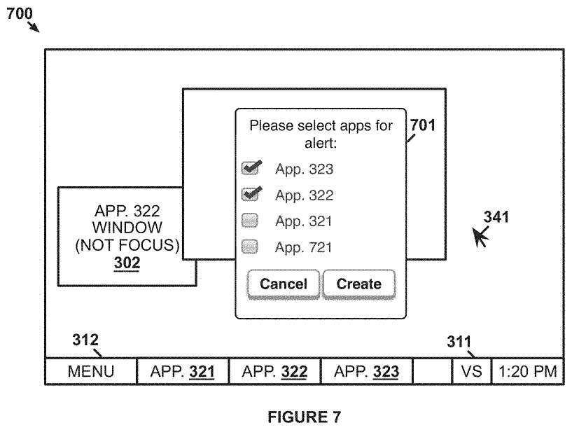

FIG. 7 illustrates desktop 700 for notifying a user about screen sharing when switching between applications. Desktop 700 is an example of desktop 300 before user 141 attempts to open a window of application 323. View-sharing client 121 displays app-selection window 701 on desktop 700. Applications that user 141 checks (i.e., selects) in app-selection window 701 using cursor 341 are applications that will trigger an alert should user 141 attempt to include a window of the application in a view being shared by view-sharing client 121. In this case, user 141 has selected application 323 and application 322 while leaving application 321 and application 721 unchecked. App-selection window 701 is just an example of how user 141 may identify applications for alerts to be generated. Other manners of enabling a user to indicate the applications may be used in other examples. Since application 323 and application 322 are selected, then popup alert 401 will be displayed by view-sharing client 121 in response to user 141 attempting to include a window of either application in the shared view, as was the case with desktops 400 and 600 above. In some examples, since window 302 is at least partially covered by window 301, user 141 selecting window 302 to become the focus window in place of window 301 may also trigger view-sharing client 121 to display popup alert 401 even though window 302 is already partially shown in the view. Similarly, in examples where the shared view only includes the focus window (i.e., window 301 in desktop 300), then user input attempting to switch the focus to window 302 would trigger popup alert 401 being displayed.

App-selection window 701 may be displayed at the instruction of user 141 (e.g., user 141 may explicitly navigate the GUI of view-sharing client 121 to display app-selection window 701) or app-selection window 701 may be displayed automatically by view-sharing client 121. For example, when initiating a view sharing session with user system 102, view-sharing client 121 may display app-selection window 701 to allow user 141 to select applications at that time. Should user 141 not select particular applications, view-sharing client 121 may alert for all applications, no applications, or may include a default selection of applications (e.g., applications that are predetermined to potentially present information that user 141 would not want other users to see).

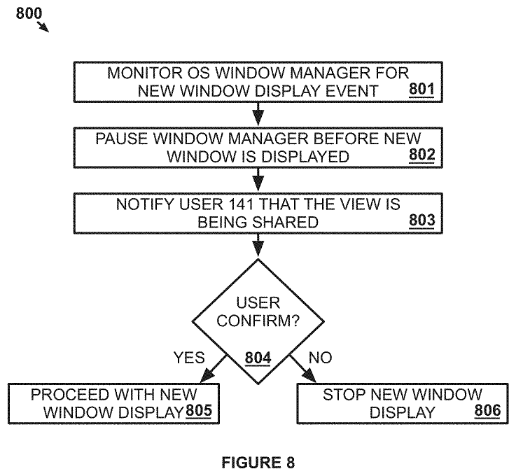

FIG. 8 illustrates operational scenario 800 to notify a user about screen sharing when switching between applications. Operational scenario 800 is an example of how view-sharing client 121 may prevent a new application window from being presented in the view being shared with user system 102. In operational scenario 800, view-sharing client 121 monitors a window manager of the OS of user system 101 to detect a new window display event (801). The new window display event may be generation of a new window for an application, de-minimizing a window for the application, bringing a window for the application to focus, or any other type of event that will include a window in the shared view that was not previously displayed in the shared view. While the examples above all refer to the window being a window of another application than one that is already presented in the view, the window in some examples may be another window of an application that already has a window included in the shared view (e.g., switching from one document window to another may display information that user 141 does not want seen by user 142). Additionally, there may be situations where user system 101 automatically opens an application window. View-sharing client 121 may be configured to recognize those new windows in addition to windows triggered manually by user input.

Upon detecting the event, view-sharing client 121 pauses the window manager before the window is displayed (802). Preferably, view-sharing client 121 only pauses the process in the window manager to display the specific window so that the window manager can still handle the display of alerts. While the window manager is paused, view-sharing client 121 notifies user 141 that the view is being shared (803). View-sharing client 121 may use an alert similar to popup alert 401 or may notify user 141 in some other manner. After notifying user 141, view-sharing client 121 waits for user 141 to confirm whether they want to continue with opening the new window (804). If user 141 confirms that they want to continue, view-sharing client 121 unpauses the window manager, which allows the window manager to proceed with the display of the new window (805). Displaying the new window allows view-sharing client 121 to capture the new window and include it in the shared view. If, however, user 141 does not confirm that the new window should be displayed, the view-sharing client 121 stops the window manager from displaying the new window (806). View-sharing client 121 may stop the new window from being displayed by explicitly instructing the window manager to stop the display, by instructing the window manager to immediately close the new window, by leaving the window manager paused (e.g., and allowing it to timeout), or may prevent the window manager from displaying the new window in some other manner.

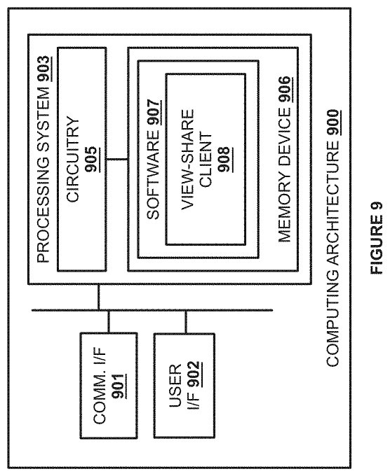

FIG. 9 illustrates computing architecture 900 for notifying a user about screen sharing when switching between applications. Computing architecture 900 is an example computing architecture for user system 101, although user system 101 may use alternative configurations. Computing architecture 900 comprises communication interface 901, user interface 902, and processing system 903. Processing system 903 is linked to communication interface 901 and user interface 902. Processing system 903 includes processing circuitry 905 and memory device 906 that stores operating software 907.

Communication interface 901 comprises components that communicate over communication links, such as network cards, ports, RF transceivers, processing circuitry and software, or some other communication devices. Communication interface 901 may be configured to communicate over metallic, wireless, or optical links. Communication interface 901 may be configured to use TDM, IP, Ethernet, optical networking, wireless protocols, communication signaling, or some other communication format—including combinations thereof.

User interface 902 comprises components that interact with a user. User interface 902 may include a keyboard, display screen, mouse, touch pad, or some other user input/output apparatus. User interface 902 may be omitted in some examples.

Processing circuitry 905 comprises microprocessor and other circuitry that retrieves and executes operating software 907 from memory device 906. Memory device 906 comprises a computer readable storage medium, such as a disk drive, flash drive, data storage circuitry, or some other memory apparatus. In no examples would a storage medium of memory device 906 be considered a propagated signal. Operating software 907 comprises computer programs, firmware, or some other form of machine-readable processing instructions. Operating software 907 includes view-share client 908. Operating software 907 may further include an operating system, utilities, drivers, network interfaces, applications, or some other type of software. When executed by processing circuitry 905, operating software 907 directs processing system 903 to operate computing architecture 900 as described herein.

In particular, view-share client 908 directs processing system 903 to capture a view displayed by a first user system to a user. The view includes a first window of a first application. View-share client 908 also directs processing system 903 to share the view with a second user system. The second user system displays the view. View-share client 908 directs processing system 903 to receive user input directing the first user system to display, in the view, a second window of a second application. Before including the second window in the view, view-share client 908 directs processing system 903 to notify the user that the view is being shared.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method comprising:
capturing a view displayed by a first user system to a user, wherein the view includes a first window of a first application;
sharing the view with a second user system, wherein the second user system displays the view;
receiving user input directing the first user system to display, in the view, a second window of a second application;
preventing the first user system from displaying the second window in the view at the first user system; and
while preventing the first user system from displaying the second window, notifying the user that the view is being shared.

2. The method of claim 1, comprising:
after notifying the user, receiving confirmation from the user that the second window should be included in the view; and
in response to receiving the confirmation, including the second window in the view.

3. The method of claim 1, wherein preventing the first user system from displaying the second window comprises:
displaying an obscured version of the second window in the view.

4. The method of claim 1, comprising:
after notifying the user, receiving an instruction from the user to cancel the user input.

5. The method of claim 1, comprising:
before receiving the user input, receiving a selection of one or more applications for which the user should be notified, wherein the selection includes the second application.

6. The method of claim 1, comprising:
receiving second user input from the user identifying one or more applications that trigger notification to the user when directed to be included in the view, wherein the one or more applications include the second application.

7. The method of claim 6, comprising:
requesting the second user input in response to initializing the sharing of the view.

8. The method of claim 6, comprising:
receiving third user input directing the first user system to display, in the view, a third window of a third application; and
in response to determining that the third application is not included in the one or more applications, including the third window in the view.

9. The method of claim 1, wherein the user input comprises user input directing the first user system to share the view.

10. The method of claim 1, wherein preventing the first user system from displaying the second window comprises:
pausing a window manager of the first user system before the second window is displayed.

11. An apparatus comprising:
one or more computer readable storage media;
a processing system operatively coupled with the one or more computer readable storage media; and
program instructions stored on the one or more computer readable storage media that, when read and executed by the processing system, direct the processing system to:
capture a view displayed by a first user system to a user, wherein the view includes a first window of a first application;
share the view with a second user system, wherein the second user system displays the view;
receive user input directing the first user system to display, in the view, a second window of a second application;
prevent the first user system from displaying the second window in the view at the first user system; and
while the first user system is prevented from displaying the second window, notify the user that the view is being shared.

12. The apparatus of claim 11, wherein the program instructions direct the processing system to:
after notifying the user, receive confirmation from the user that the second window should be included in the view; and
in response to receiving the confirmation, include the second window in the view.

13. The apparatus of claim 11, wherein to prevent the first user system from displaying the second window, the program instructions direct the processing system to:
display an obscured version of the second window in the view.

14. The apparatus of claim 11, wherein the program instructions direct the processing system to:
after notifying the user, receive an instruction from the user to cancel the user input.

15. The apparatus of claim 11, wherein the program instructions direct the processing system to:
before receiving the user input, receive a selection of one or more applications for which the user should be notified, wherein the selection includes the second application.

16. The apparatus of claim 11, wherein the program instructions direct the processing system to:
receive second user input from the user identifying one or more applications that trigger notification to the user when directed to be included in the view, wherein the one or more applications include the second application.

17. The apparatus of claim 16, wherein the program instructions direct the processing system to:
request the second user input in response to initializing the sharing of the view.

18. The apparatus of claim 16, wherein the program instructions direct the processing system to:
receive third user input directing the first user system to display, in the view, a third window of a third application; and
in response to determining that the third application is not included in the one or more applications, include the third window in the view.

19. The apparatus of claim 11, wherein to prevent the first user system from displaying the second window, the program instructions direct the processing system to:
pause a window manager of the first user system before the second window is displayed.

20. One or more non-transitory computer readable storage media having program instructions stored thereon that, when read and executed by a processing system, direct the processing system to:
capture a view displayed by a first user system to a user, wherein the view includes a first window of a first application;
share the view with a second user system, wherein the second user system displays the view;
receive user input directing the first user system to display, in the view, a second window of a second application;
prevent the first user system from displaying the second window in the view at the first user system; and
while the first user system is prevented from displaying the second window, notify the user that the view is being shared.
